(19) United States
(12) Patent Application Publication
(10) Pub. No.: US 2025/0329873 A1
(43) Pub. Date: Oct. 23, 2025

(54) BATTERY SEPARATOR AND PREPARATION METHOD THEREFOR, AND BATTERY

(71) Applicants: JIANGSU SENIOR NEW MATERIAL TECHNOLOGY CO., LTD, Changzhou (CN); SHENZHEN SENIOR TECHNOLOGY MATERIAL CO., LTD, Shenzhen (CN)

(72) Inventors: Dandan YANG, Changzhou (CN); Xiang PING, Shenzhen (CN); Huizhen HUANG, Shenzhen (CN); Yulin LIN, Shenzhen (CN)

(73) Assignees: JIANGSU SENIOR NEW MATERIAL TECHNOLOGY CO., LTD, Changzhou (CN); SHENZHEN SENIOR TECHNOLOGY MATERIAL CO., LTD, Changzhou (CN)

(21) Appl. No.: 18/870,411

(22) PCT Filed: Jun. 28, 2023
(86) PCT No.: PCT/CN2023/103379

§ 371 Date: Nov. 28, 2024

(30) Foreign Application Priority Data
Jun. 2, 2022 (CN) 202210622326.2

(51) Int. Cl. H01M 50/426; H01M 50/403; H01M 50/434; H01M 50/443; H01M 50/457

(52) U.S. Cl. CPC H01M 50/426; H01M 50/403; H01M 50/434; H01M 50/443; H01M 50/457

(57) ABSTRACT

A battery separator and a preparation method therefor, and a battery. The battery separator includes a substrate; one side or two sides of the substrate are coated with a polymer layer, the polymer layer is mainly formed by mixing a first polymer, a second polymer, first ceramic particles and second ceramic particles, the particle size of the first ceramic particles is 0.01-0.3 μm; the first ceramic particles have higher surface activity; the specific surface area of the first ceramic particles is larger than or equal to 50 m²/g.

### CROSS-REFERENCE TO THE RELATED APPLICATIONS

This application is the national phase entry of International Application No. PCT/CN2023/103379, filed on Jun. 28, 2023, which is based upon and claims priority to Chinese Patent Application No. 202210622326.2, filed on Jun. 2, 2022, the entire contents of which are incorporated herein by reference.

### TECHNICAL FIELD

The present disclosure relates to the field of batteries, and in particular relates to a battery separator and a preparation method therefor, and a battery.

### BACKGROUND

The lithium battery separator is one of the four core components of a lithium-ion battery, and plays roles of separating positive and negative electrodes, allowing lithium ions to pass through, and insulating electrons in the lithium-ion battery. The performance of the separator directly affects the performance of lithium-ion battery, and is one of the key technologies restricting the development of the lithium-ion battery. When the battery is in extreme use conditions such as continuous charging and discharging or high temperature, the thermal contraction and deformation of the separator may lead to a short circuit of positive and negative electrodes, so as to result in a series of thermal runaway effects, which seriously affects the safety performance of the lithium-ion battery. Additionally, the electrodes in the prior lithium-ion battery are easily expanded and contracted during continuous charging and discharging cycles, so as to form gaps between the electrodes and the separator, which results in a decrease in the cycle life of the battery. Therefore, it needs to improve the adhesive force between the electrodes and the separator, so as to further improve the safety of the separator.

### SUMMARY

The present disclosure provides a battery separator and a preparation method therefor, and a battery, so as to improve a heat resistance and an adhesive force of the battery separator.

A first aspect of the present disclosure is to provide a battery separator, including a substrate, wherein a polymer layer is coated on a single side or two sides of the substrate, and the polymer layer is mainly formed by mixing a first polymer, a second polymer, a first ceramic particle, and a second ceramic particle, wherein particle sizes of the first ceramic particle and the second ceramic particle are 0.01 μm-1 μm, and the first ceramic particle has a strong surface activity having a specific surface area ≥50 m²/g.

In some embodiments, a particle size of the first ceramic particle is 0.01-0.3 μm.

In some embodiments, a particle size of the second ceramic particle is 0.3-1 μm, and the particle size of the first ceramic particle is smaller than that of the second ceramic particle.

In some embodiments, an absolute value of a particle size difference between the first ceramic particle and the second ceramic particle is 0.2 μm-0.99 μm, and the particle size of the first ceramic particle is smaller than that of the second ceramic particle.

In some embodiments, a mass-percentage ratio of the first ceramic particle to the second ceramic particle is: 10%-50%: 50%-90%.

In some embodiments, the mass-percentage ratio of the first ceramic particle to the second ceramic particle is: 10%-35%: 65%-90%.

In some embodiments, the first polymer is a high-adhesive polymer resin, and the high-adhesive polymer resin is a binder resin, wherein the battery separator thereof has a dry-press adhesive force ≥20 N/m, and a wet-press adhesive force ≥8 N/m.

In some embodiments, the high-adhesive polymer resin includes a copolymer (referred to as PVDF-HFP copolymer below) of polyvinylidene difluoride and hexafluoropropylene, sodium carboxymethyl cellulose (CMC), and a polymethacrylate polymer (e.g., PMMA).

In some embodiments, in the PVDF-HFP copolymer, a mass percentage of HFP in the copolymer is 4% to 20%; a molecular weight of the PVDF-HFP copolymer is 300,000 to 500,000; a melting point is 125˜150° C.; and a melt viscosity is 15˜35 cps.

In some embodiments, the second polymer is a heat-resistant polymer resin, and its melting point is larger than or equal to 180° C.

In some embodiments, the heat-resistant polymer resin includes one or two of polyetherimide [PEI], polyimide [PI], polyvinylidene fluoride-tetrafluoroethylene-propylene [P(PVDF-TFE-P)] terpolymer, and polyvinylidene difluoride-trifluoroethylene-chlorotrifluoroethylene [P(VDF-TrFE-CTFE)] terpolymer.

In some embodiments, a mass-percentage ratio of the first polymer to the second polymer is: 10˜40%: 60˜90%.

In some embodiments, based on a mass sum of the first polymer, the second polymer, the first ceramic particle, and the second ceramic particle in the polymer layer, a mass percentage of a sum of the first ceramic particle and the second ceramic particle in the polymer layer is 30% to 70%.

A second aspect of the present disclosure is to provide a battery separator including a substrate, wherein a polymer layer is coated on a single side or two sides of the substrate, and the polymer layer mainly includes ceramic particles, wherein the ceramic particles form raised island structures on a surface of the polymer layer.

In some embodiments, a diameter of the island structures is 0.8-2 μm.

A third aspect of the present disclosure is to provide a preparation method of the battery separator for preparing the battery separator described in any one of the foregoing items, wherein the method includes:
selecting a mixture of the first polymer and the second polymer, and dissolving the mixture of the first polymer and the second polymer in a solvent to obtain a premixed slurry A;
screening the first ceramic particle and the second ceramic particle, wherein the particle sizes of the first ceramic particle and the second ceramic particle are 0.01 μm-1 μm, and the specific surface area of the first ceramic particle is ≥50 m²/g; adding two types of the ceramic particles of different particle sizes simultaneously or successively to the premixed slurry A and mixing, so as to obtain a polymer-layer coating slurry; and
coating the polymer-layer coating slurry on the single side or two sides of the substrate, so as to obtain the battery separator.

A fourth aspect of the present disclosure is to provide a battery, including a battery separator, a positive electrode, a negative electrode, and an electrolyte, wherein the battery separator is the battery separator as described in any one of the foregoing items.

In the battery separator and the preparation method therefor and the battery provided by the present disclosure, the polymer layer is coated on the single side or two sides of the substrate, wherein the polymer layer includes both the first polymer and the second polymer therein, and two types of ceramic particles of different particle sizes are further added; the particle sizes of the two types of ceramic particles are 0.01 μm-1 μm; and the specific surface area of the first ceramic particle is ≥50 m²/g. Thereby, compared with the prior art, the solutions of the present disclosure include at least the following technical effects.

1) The first ceramic particle of the present disclosure has a strong surface activity, and is compatible with both the first polymer and the second polymer in the slurry system, that is, the first polymer and the second polymer are not inherently compatible in the solvent. The first ceramic particle can play a role of surfactant, so that the first polymer and the second polymer are compatible in the solvent; and it can also improve the adhesion of the polymer slurry to the substrate. The second ceramic particle is taken as the filler to increase a surface roughness for the polymer layer in the present disclosure, wherein the surface is coated by the polymer, which improves the adhesive force of the polymer to the electrode plate.

2) The ceramic particles in the present disclosure are taken as the fillers in the polymer layer, so that the ceramic particles form a plurality of raised island structures on an outer surface of the polymer layer, so as to well achieve an engaging and anchoring effect with the first ceramic layer at the bottom, which improves the adhesion effect between coating layers and improves a roughness of the outer surface of the separator, so that the separator surface is attached to the electrode plate more strongly, which further improves the adhesive force of the separator to the electrode plate.

3) During the process of preparing the polymer-layer coating slurry, since the polar groups contained in the surface of the first polymer and the second polymer in the polymer layer have an adsorption effect on the surface groups of the ceramic particle, the ceramic particle can be uniformly dispersed in the slurry, which can improve the liquid absorbing effect of the separator well. The coated ceramic particles can be uniformly distributed on the surface of the coating layer, and the characteristics of the ceramic particles themselves can improve the heat resistance of the separator, so that the heat on the separator surface is uniformly distributed.

4) The ceramic particles of different particle sizes in the polymer layer are provided to improve a stacking density of the coating layer, which can limit the thermal shrinkage of the separator at the high temperature above 150° C., so as to further improve the thermal stability of the separator.

5) The ceramic particles of two particle sizes in the present disclosure are selected, so that the particle size of the ceramic particle having a small particle size is 0.01 μm≤D50≤0.3 μm, and the particle size of the ceramic particle having the large particle size is 0.3 μm≤D50≤1 μm. Since the surface energy of the ceramic particle having the small particle size is larger, which is specifically manifested in that the specific surface area is ≥50 m²/g, the mixed slurry of the first polymer and the second polymer with different heat resistances can be stabilized, so as to solve the problem of compatibility and to form a completely uniform mixed slurry system. The ceramic particle having the large particle size can form the raised island structures on the surface of the polymer layer, which improves the adhesive force of the coating layer.

Of course, any solution of the present disclosure does not need to realize the above technical effects at the same time.

### BRIEF DESCRIPTION OF THE DRAWINGS

The present disclosure is further illustrated below in conjunction with the drawings and specific embodiments.

FIG. 1 shows a schematic structure diagram of a battery separator provided by an embodiment of the present disclosure;

FIG. 2 shows a schematic structure diagram of a battery separator provided by another embodiment of the present disclosure;

FIG. 3 shows a schematic flow diagram of a preparation method of a battery separator provided by an embodiment of the present disclosure; and

FIG. 4 shows a schematic flow diagram of a preparation method of a battery separator provided by another embodiment of the present disclosure.

### REFERENCE NUMBERS

101—base film;
102—first ceramic coating layer;
103—polymer layer; and
104—island structure.

### DETAILED DESCRIPTION OF THE EMBODIMENTS

The technical solutions in the embodiments of the present disclosure will be clearly and completely described below. It is obvious that the embodiments described are only partial embodiments of the present disclosure and not all of them. Based on the embodiments in the present disclosure, all other embodiments obtained by a person of ordinary skill in the art without inventive efforts all fall within the scope of protection of the present disclosure.

The applicant has performed a series of studies and experiments on the prior separators before providing the present disclosure.

The preparation process of a separator with organic adhesive layer is: a high-temperature-resistant inorganic ceramic coating layer is coated on one side or two sides of PE or PP or PE/PP composite substrates first, wherein most of the high-temperature-resistant inorganic ceramic coating layers are obtained by coating the water-soluble slurry and drying; and then an organic adhesive layer is coated on two sides of the high-temperature-resistant inorganic ceramic coating layer. For this method, the applicant found that during the process of coating the organic adhesive layer, partial inorganic ceramic particles in the ceramic layer will fall off after the coagulating bath and washing, which results in a significant decrease in the stability of the high temperature resistance of the separator. Moreover, during the process of coating the organic adhesive layer, only a pure PVDF-based polymer layer was coated on the outer surface of the separator, wherein the interfacial adhesive force between this polymer layer and the electrode plate is generally 20-50 gf/25 mm, which results in it difficult to further improve the level of adhesive force by the prior art.

Meanwhile, after analyzing the separator with organic adhesive layer, the applicant found that this organic adhesive layer is basically a pure-polymer bonding resin coating layer, and a pure PVDF-based polymer layer is on the surface of the separator, wherein the PVDF-based polymer layer has a poor adhesion effect on the bottom ceramic layer, so that it does not have any anchoring or engaging effect. Even if the applicant tried to add inorganic ceramic particles to the polymer bonding resin coating layer, it was found that it can only slightly increase the adhesive force. The reason is that the addition of the ceramic particles results in a relative decrease in the polymer resin content, and the improvement for the overall level of adhesive force is limited. Moreover, the applicant found that the PVDF-based resin can penetrate into the ceramic layer under an action of the solvent, which consumes partial adhesion property.

In view of this, in order to improve the heat resistance and adhesion of the battery separator, the present disclosure provides a battery separator and a preparation method therefor, and a battery.

The technical solutions of the present disclosure are described in detail below by specific embodiments. These following specific embodiments can be combined with each other, and the same or similar concepts or processes may not be repeated in certain embodiments.

The battery separator of the present disclosure includes a substrate, wherein a polymer layer is coated on one side or two sides of the substrate, and the polymer layer is mainly formed by a mixture of a first polymer, a second polymer, a first ceramic particle, and a second ceramic particle, wherein the particle sizes of the first ceramic particle and the second ceramic particle are 0.01 μm-1 μm, and a specific surface area of the first ceramic particle is ≥50 m²/g.

The particle sizes of the first ceramic particle and the second ceramic particle can be, for example, any point value of 0.01 μm, 0.02 μm, 0.03 μm, 0.04 μm, 0.05 μm, 0.06 μm, 0.07 μm, 0.08 μm, 0.09 μm, 1 μm, or a range between any two point values.

The specific surface area of the first ceramic particle can be, for example, any point value of 50 m²/g, 60 m²/g, 70 m²/g, 80 m²/g, 90 m²/g, 100 m²/g, 110 m²/g, 120 m²/g, 130 m²/g, 140 m²/g, 150 m²/g, or a range between any two point values.

As an embodiment, the particle size of the first ceramic particle is 0.01-0.3 μm. Further, the particle size of the second ceramic particle is 0.3-1 μm. The particle size of the first ceramic particle is smaller than that of the second ceramic particle.

As an embodiment, the first polymer is a high-adhesive polymer resin. The high-adhesive polymer resin described herein refers to a binder resin that can ensure a good adhesive property under the dry-press condition and can also remain a good adhesive property after soaked and wet by the electrolyte. Further, the high-adhesive polymer resin means that the wet-press adhesive force is ≥8 N/m, wherein the wet-press adhesive force is an adhesive strength tested at the time of peeling after it is soaked by the electrolyte and then pressed; and the dry-press adhesive force is ≥20 N/m, wherein the dry-press adhesive force is the adhesive strength tested at the time of peeling after the separator and the electrode plate are stacked together and then pressed thermally without soaked by the electrolyte. In some embodiments, the high-adhesive polymer resin can be, for example, a PVDF-HFP copolymer. Specifically, the high-adhesive polymer resin can be the PVDF-HFP copolymer with a melting point of 125˜150° C. and a melt viscosity of 15˜35 cps. Of course, the present disclosure is not limited herein, and other high-adhesive polymer resins are also within the scope of protection of the present disclosure.

As an embodiment, the second polymer is a heat-resistant polymer resin. Further, the heat-resistant polymer resin refers to a high-heat-resistant polymer resin material with a melting point more than 180° C.

Compared with other organic adhesive coated separators, the first ceramic layer is coated on one side or two sides of the substrate on the battery separator of the present disclosure, wherein the first ceramic layer can be an existing ceramic coating layer, such as a nanofiber coating layer or a nanoscale alumina coating layer; and at the same time, the polymer layer is coated on the surface of one side or two sides of the first ceramic layer, wherein two types of fillers of ceramic particles of different particle sizes are added in the polymer layer to form a certain backbone support structure, which has the stronger adhesion than the pure-polymer bonding resin coating layer.

The surface of the pure organic adhesive coated separator only has a PVDF polymer layer, wherein the PVDF polymer layer has a poor adhesive effect on the bottom ceramic layer, so that it does not have any anchoring or engaging effect; and the PVDF can penetrate into the ceramic layer under the action of the solvent, which consumes the adhesion of the PVDF. However, as for the mixed coating of polymer and ceramic, firstly, since the polar groups on the surface of the polymer have an adsorption effect on the surface groups of the ceramic particle, the ceramic particle can be uniformly dispersed in the slurry. The coated ceramic particles are uniformly distributed on the surface of the coating layer, and the characteristic of the ceramic itself can improve the heat resistance of the separator, so that the heat is uniformly distributed. Secondly, the plurality of raised island structures formed by the ceramic particles can play a good role of engaging and anchoring with the first ceramic layer at the bottom, so as to improve the adhesion effect of the coating layer.

In the present disclosure, since the ceramic particle improves the roughness of the polymer layer, the friction force between its surface and the surface of the first ceramic layer at the bottom is increased, which makes it difficult to peel off the polymer layer. The raised structures on the surface of the polymer layer are like rivets, which can deeply insert into gaps of the ceramic layer at the bottom, so as to form multiple adhesion reinforcement points, so that the polymer layer is difficult to peel off.

The battery separator of the present disclosure has the good thermal stability at the high temperature, and especially the thermal stability effect under the high temperature condition of 150° C. and above is better than that of the prior art, which can further improve battery safety. At the same time, the adhesion between the special heat-resistant and high-adhesion polymer resin coating layer and the electrode plate is better than the adhesion of the regular PVDF coating layer, which can improve the hardness of the battery, and reduce the gaps generated by the electrode plate and the separator during the charging and discharging cycles of the battery, wherein the gaps lead to a reduction of the cycle life.

Additionally, the separator involved in the present disclosure can meet the conditions that the thermal shrinkage rate of 150° C.*0.5H is ≤10%, the adhesive force can reach 50-80 gf/25 mm, and the liquid absorption is ≥6.5 g/m².

In another embodiment, a first ceramic coating layer is further included. The battery separator includes the substrate, wherein the first ceramic coating layer is coated on one side or two sides of the substrate, and the polymer layer is coated on the first ceramic coating layer. The other structures are the same as that of the above embodiments and will not be expanded herein.

In particular, when the polymer layer is coated on the first ceramic coating layer, the separator can meet the conditions that thermal shrinkage rate of 150° C.*0.5H is ≤5%, the adhesive force can reach 50-80 gf/25 mm, and the liquid absorption is ≥6.5 g/m².

If the ceramic particle of the polymer layer is too large, it is easy to combine with the ceramic of small particles to form a secondary particle with a larger particle size, and the thickness of the coating layer is difficulty controlled and exceed the range of the requirement easily. Therefore, under this circumstances, the polymer layer is difficult to form a dense layer, which results in that the polymer resin adhesive is easy to follow the solvent to penetrate into micropores formed on the first ceramic layer previously, which causes too large air permeability, thereby affecting the permeability of lithium ions. In some embodiments, the first ceramic particle with a particle size of 0.01 μm≤D50≤0.3 μm and the second ceramic particle with a particle size of 0.3 μm≤D50≤1 μm are combined. The ceramic particle with the small particle size (0.01-0.3 μm) has the characteristic that the specific surface area is ≥50 m²/g. Under the action of its surface energy and —OH hydrogen bond, the high heat-resistant resin and PVDF-HFP form a uniform and stable adhesive slurry. At this time, the large-size ceramic particles are floating up in the adhesive slurry like multiple suspending particles. The large-size ceramic particles can be uniformly dispersed in the entire slurry system and can be stably suspended in the slurry through solvation effect by solvent molecules and the hydrogen bond between the polar group on the surface of the large-size ceramic particle and the resin. After nonsolvent induce phase separation, the large-size ceramic particle is firmly grasped by the macromolecular network formed by the homogeneous adhesive polymer layer, so that it is uniformly embedded in the coating layer network. Since it has a larger particle size, multiple raised island structures are appeared. Moreover, as an additive to increase the roughness for the coating layer, the large-particle ceramic not only improves the adhesive force of the separator, but also improves the liquid absorption rate for the electrolyte (—OH on the ceramic particle surface and the electrolyte can play a certain role of the hydrogen bond, and the polar groups on the ceramic particle surface and the polar groups in the electrolyte molecules are easily attracted to each other, so that the electrolyte wettability can be improved and the electrolyte absorption rate can also be improved), and at the same time, the porosity of the coating layer can be increased and the air permeability increment is reduced. The small-particle ceramic improves the compatibility of the slurry. The nanoscale ceramic particle has a strong surface activity and has a certain surface energy, which is easier to attract oxygen atoms on the —C═O group in the polyimide molecule and the lone-pair electron on the N atom in the molecule to form the hydrogen bond. It can also play a certain effect on polar groups of —CF3 in PVDF-HFP, so that they show an emulsion state in the whole slurry system, and they can coexist stably without layering, which improves the compatibility for them.

In particular, in order to improve the thermal stability of the separator, it is to provide the ceramic particles of different particle sizes by a certain ratio in the polymer layer, so as to improve the stacking density of the coating layer, which limits the contraction space of the separator at the high temperature above 150° C. The ratio of inorganic ceramic particles with a particle size of 0.01 μm≤D50≤0.3 μm and a particle size of 0.3 μm≤D50≤1 μm is: 10%-50%: 50%-90%. In other embodiments, the ratio of inorganic ceramic particles with the particle size of 0.01 μm≤D50≤0.3 μm and the particle size of 0.3 μm≤D50≤1 μm is: 10%-35%: 65%-90%.

The first ceramic particle and the second ceramic particle in the polymer layer can be a gas phase ceramic particle or a nano-ceramic particle. For example, the ceramic particle can be at least one of alumina, boehmite, SiO₂, CaCO₃, ZrO₂, and TiO₂.

The substrate in the present disclosure can be a base film, such as a polyolefin base film, a PET film, a BOPP film, and a coated film that is obtained by coating on the surface of the above base film, wherein the polyolefin film can be PE, PP, and a composite separator of PP and PE.

In some embodiments, the polymer layer is coated on two sides of the base film. In some other embodiments, the first ceramic coating layer is coated on a single side or two sides of the base film first, and then the polymer layer is coated on the single side or two sides. The single-surface coating means that only the single surface is coated, so that the single side has adhesion. The double-surface coating means that two surfaces both have the adhesion, which can realize the adhesion between two surfaces of the separator and the positive and negative electrode plates, and inhibit the growth of lithium dendrites, so as to further improve the wettability of the separator to the electrolyte. The thickness of the base film can be 5-12 μm; the thickness of the first ceramic coating layer on the single side of the base film can be 0.5-2.5 μm; and the thickness of the polymer layer on the single side can be 0.3-2.5 μm. If the thickness of the polymer layer is too large, it affects the energy density of battery; and if the thickness is too small, the adhesive force is not enough.

In some embodiments, the first ceramic coating layer is a high-temperature-resistant inorganic ceramic coating layer, and the high-temperature-resistant inorganic ceramic coating layer can be an existing high-temperature-resistant inorganic ceramic coating layer, such as a nanofiber coating layer, a nanoscale alumina coating layer, a silica ceramic coating layer, and a titanium oxide ceramic coating layer. For example, the high-temperature-resistant inorganic ceramic coating layer includes: the inorganic ceramic filler particles (which can be the SiO₂, alumina, boehmite, TiO₂, MgO₂ and other inorganic ceramic particles, or the nano-fiber), acrylate adhesive, polyacrylic adhesive, dispersing agent, wetting agent, thickening agent, and antifoaming agent.

In order to provide a high adhesion performance, the present disclosure selects a mixture of a polymer resin with the high adhesive property and a heat-resistant polymer resin as the component of the polymer layer. Meanwhile, different from the general PVDF polymer layer, the high-viscosity and high heat-resistant polymer resin mixture coating layer takes inorganic particles as the filler, so as to form multiple raised island structures on the outer surface of the separator, which improves the roughness of the outer surface of the separator, so that the separator surface engages the electrode plate more strongly, and thus it further improves the adhesive force of the separator to the electrode plate.

In particular, based on a mass sum of the first polymer, the second polymer, the first ceramic particle, and the second ceramic particle in the polymer layer, a mass percentage of a sum of the first ceramic particle and the second ceramic particle in the polymer layer is 30% to 70% (which refers to a ratio of the sum of the ceramic particles of two particle sizes). Specifically, the mass percentage of the sum of the ceramic particles of two particle sizes in the polymer layer can be, for example, 30%, 35%, 40%, 45%, 50%, 55%, 60%, 65%, and 70%. Of course, it can also be any other value from 30% to 70%.

In some embodiments, the first polymer in the polymer layer is selected from the PVDF-HFP copolymer, and the second polymer is selected from at least one of the polyetherimide and polyimide. The main characteristic of the polyimide and the polyetherimide is a high melting point, wherein the melting point is higher than 200° C. with a high heat resistance, which is not achievable by the normal resin material; and the dielectric constant thereof is higher, so that the breakdown resistance voltage of the coating layer is higher.

Of course, the second polymer is not limited in this way, and it can be any one or two of the polyetherimide, the polyimide, the polymethylmethacrylate, the polyvinylidene fluoride-tetrafluoroethylene-propylene terpolymer, and the polyvinylidene difluoride-trifluoroethylene-chlorotrifluoroethylene terpolymer.

In some embodiments, in the PVDF-HFP copolymer, the mass percentage of HFP in the copolymer is 4% to 20%, and the molecular weight of the PVDF-HFP copolymer is 300,000 to 500,000. The molecular weight of the PVDF-HFP copolymer is, for example, any point value of 300,000, 310,000, 320,000, 330,000, 340,000, 350,000, 360,000, 370,000, 380,000, 390,000, 400,000, 410,000, 420,000, 430,000, 440,000, 450,000, 460,000, 470,000, 480,000, 490,000, 500,000, and range between any two point values. When the molecular weight is larger than 500,000, it is easily fallen or dissolved out due to the poor adhesion when the slurry is transferred to the substrate. The mass percentage of HFP in the copolymer can be any point value of 4%, 5%, 6%, 7%, 8%, 9%, 10%, 11%, 12%, 13%, 14%, 15%, 16%, 17%, 18%, 19%, 20%, or range between any two point values. When the content of HFP exceeds 20%, the wet-press adhesive force between the separator and the electrode plate is less than 3 N/m.

In some embodiments, the polymer in the polymer layer is obtained by mixing the PVDF-HFP copolymer and the polyimide, wherein the mass-percentage ratio of PVDF-HFP and polyimide is 30˜50:50˜70. The mass-percentage ratio of the PVDF-HFP and the polyimide can be 30:50˜70, 35:50˜70, 40:50˜70, 45:50˜70, and 50:50˜70. In this ratio, the proportion of polyimide cannot be too low. If it is too low, the heat resistance and the adhesion will be reduced; and if it is too high, the adhesion of the slurry will be decreased, and the coating layer is easily fallen off after coming out of the solidification tank.

The structure composition of the battery separator provided by the present disclosure is referred to FIG. 2. As shown in FIG. 2, the battery separator includes: the base film 101, wherein the first ceramic coating layer 102 is coated on two sides of the base film 101; the polymer layer 103 is coated on the first ceramic layer 102; the polymer layer 103 mainly includes the ceramic particles; and the ceramic particles form the raised island structures 104 on the surface of the polymer layer 103.

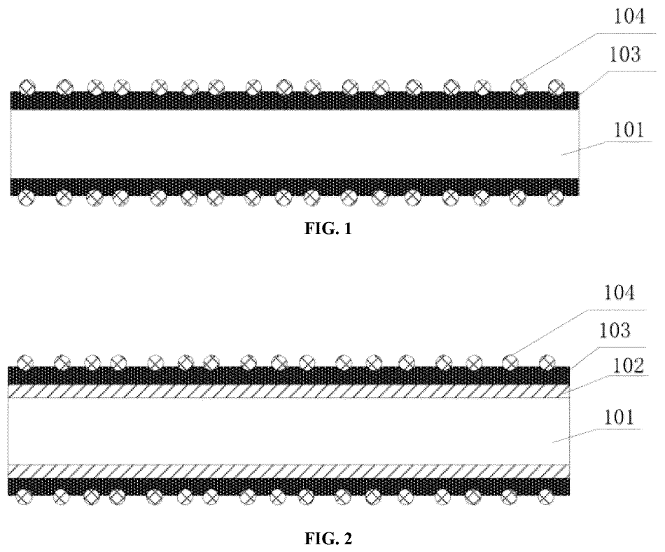

In the embodiment, the first ceramic coating layer 102 is coated on two sides of the base film 101, and the polymer layer 103 is coated on two sides of the first ceramic coating layers 102. However, in the present disclosure, the first ceramic coating layer can only be coated on one side of the base film, and the polymer layer is coated on the corresponding first ceramic coating layer. Of course, in other embodiments, as shown in FIG. 1, the first ceramic coating layer 102 can also be omitted, and the polymer layer 103 is directly coated on the single side or two sides of the base film 101.

As shown in the foregoing description, the polymer layer 103 is mainly formed by a mixture of the first polymer, the second polymer, the first ceramic particle, and the second ceramic particle, wherein the particle sizes of the first ceramic particle and the second ceramic particle are 0.01 μm-1 μm, and the specific surface area of the first ceramic particle is 50 ˜150 m²/g.

The diameter of the raised island structure 104 is close to the particle size of the large-size ceramic particle. Specifically, the diameter of the island structure 104 can be, for example, 0.8-2 μm. Since the large-size ceramic particle is embedded into the coating layer network, the height of the protrusion of the island structure 104 is about ⅓˜½ of 0.3-1 μm. It is to be understood that the diameter of the island structure herein refers to an average value of the length of connecting lines of the edges of the shape of the island structure presenting in the separator plane, and the height of the protrusion of the island structure refers to a height of the island structure beyond the surface of the coating layer.

In order to obtain the above battery separator, the embodiment of the present disclosure further provides a preparation method of the battery separator for preparing any one of the mentioned battery separators.

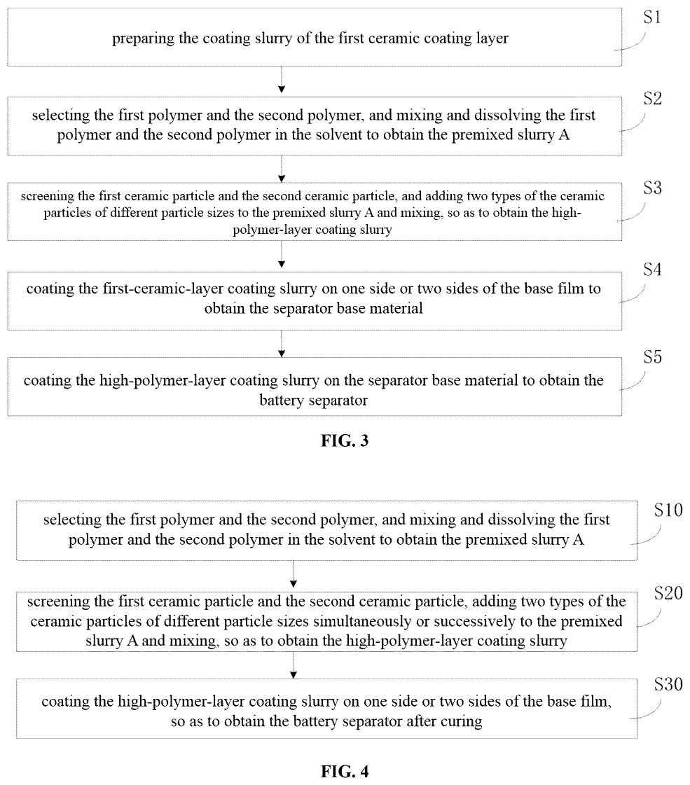

Referring to FIG. 3, in an embodiment, the preparation method of the coating layer for the battery separator includes the following steps:
S1: preparing the coating slurry of the first ceramic coating layer;
S2: selecting the first polymer and the second polymer, and mixing and dissolving the first polymer and the second polymer in the solvent to obtain the premixed slurry A;
S3: screening the first ceramic particle and the second ceramic particle, wherein the particle sizes of the first ceramic particle and the second ceramic particle are 0.01 μm-1 μm, and the particle size difference between the first ceramic particle and the second ceramic particle is 0.2 μm-0.99 μm; adding two types of the ceramic particles of different particle sizes simultaneously or successively to the premixed slurry A and mixing, so as to obtain the polymer-layer coating slurry;
S4: coating the first-ceramic-layer coating slurry on one side or two sides of the base film, so as to obtain the substrate after curing; and
S5: coating the polymer-layer coating slurry on the substrate, so as to obtain the battery separator after curing.

In other embodiments, according to this method, the step can be divided into multiple steps or the order thereof can be changed without affecting the experimental results. For example, S4 can also precede S2 in the above steps, and the present disclosure is not limited thereto.

In another embodiment, referring to FIG. 4, the preparation method of the coating layer for the battery separator includes the following steps:
S10: selecting the first polymer and the second polymer, and mixing and dissolving the first polymer and the second polymer in the solvent to obtain the premixed slurry A;
S20: screening the first ceramic particle and the second ceramic particle, wherein the particle sizes of the first ceramic particle and the second ceramic particle are 0.01 μm-1 μm, and the specific surface area of the first ceramic particle is 50˜150 m²/g; adding two types of the ceramic particles of different particle sizes simultaneously or successively to the premixed slurry A and mixing, so as to obtain the polymer-layer coating slurry; and
S30: coating the polymer-layer coating slurry on one side or two sides of the base film, so as to obtain the battery separator after curing.

The polymer layer (the high-heat-resistant and high-adhesive separator) involved in the present disclosure is accomplished by the NIPS process. The NIPS is non-solvent induced phase separation, and its specific process route includes: transferring the coating slurry to two surfaces of the substrate, and then immersing it into the solidification tank for phase conversion, washing, drying, and winding.

The molecular weight of the PVDF-HFP selected by the present disclosure reaches 300,000˜500,000, and this range ensures that the NIPS process can be realized smoothly. The NIPS process causes that the separator will enter the mixed phase of non-solvent and solvent after the coating is completed, which requires that the wet-coated slurry layer has a pretty high adhesion to the substrate, otherwise it will be easily washed away by the mixed solution of non-solvent and solvent, or be scraped off during the conveying process of the separator.

The product performance of some embodiments of the present disclosure will be analyzed experimentally below.

### Example 1

The polymer-layer coating slurry was mainly prepared by the following steps.

The PVDF-HFP copolymer (the average molecular weight was 300,000, and the proportion of the hexafluoropropylene (HFP) was 4%) of the first polymer, the second polymer (polyetherimide), the first ceramic powder (the particle size D50=0.05 μm), and the second ceramic powder (the particle size D50-0.6 μm) were prepared. The slurry was prepared by the following steps: based on the mass sum of the first polymer, the second polymer, the first ceramic particle, and the second ceramic particle, the first polymer with a weight percentage of 11% and the second polymer with a weight percentage of 19% were dissolved in an N-methyl-2-pyrrolidone (NMP) solvent (which was fully stirred at 60° C. for 24 h) to obtain the premixed slurry A; the first ceramic powder with the weight percentage of 20% was added to the above premixed slurry A after the polymer in the premixed slurry A was completely dissolved, which was fully stirred for 60 min at 30° C. and 1800 rpm/min, and the resultant was mixed and dispersed uniformly to obtain the mixed slurry B; the second ceramic powder with the weight percentage of 50% was added to the above mixed slurry B, which was fully stirred for 60 min at 30° C. and 1800 rpm/min; and the total solid content of the slurry was controlled to be 10%, so as to obtain the coating slurry used in the present disclosure.

The first ceramic powder in the Example 1 and the Comparative Example was the gas-phase alumina ceramic, and the second ceramic powder was the silicon oxide ceramic.

The coated separator can be made by the following steps.

The ceramic layer was coated on two opposite surfaces of the PE separator to prepare the substrate (the preparation was described later); the coating slurry obtained above was coated on surfaces of two opposite surface layers of the substrate by using a slightly concave roller; and the coated substrate was immersed in a solidification tank at a temperature of 20° C. and with a mixture solvent concentration of 20% (the mass-percentage ratio concentration of the first solvent in the mixture included first solvent and second solvent) for the phase conversion, and the coated separator (i.e., battery separator) was obtained after the non-solvent washing and oven drying. The first solvent includes at least one of acetone, dichloromethane, benzene, toluene, xylene, dimethylformamide, dimethylsulfoxide, trimethyl phosphate, cyclohexane, cyclohexanone, toluene cyclohexanone, chlorobenzene, dichlorobenzene, dichloromethane, ethyl ether, propylene oxide, methylethyl ketone, methylbutyl ketone, methylisobutyl ketone, ethylene glycol monomethyl ether, ethylene glycol monoethyl ether, ethylene glycol monobutyl ether, tetrahydrofuran, trichloromethane, and N-methyl-2-pyrrolidinone; and the second solvent includes at least one of ethanol, water, glycerol, ethyl acetate, and polyethylene glycol. The first solvent in Example and Comparative Examples of the present disclosure was N-methyl-2-pyrrolidone, and the second solvent was water.

The substrate was prepared by the following steps.

(1) The preparation of the slurry used for coating the first ceramic layer in the Examples and Comparative Examples of the present disclosure includes following steps.

The 50 kg of inorganic ceramic powder was added to the 57 kg of deionized water, and was dispersedly stirred in a mixer for 30 min; the 10 kg of sodium carboxymethyl cellulose (CMC) aqueous solution with a concentration of 2% was added and continued to dispersedly stir for 30 min; the 1.0 kg of polyacrylic adhesive (the emulsion solid content was 35%) was added and continued to dispersedly stir for 30 min; the resultant was sanded for 60 min (flow rate: 1000 L/h; rotary speed: 750 rpm; and stirring speed: 20 rpm); and finally, the 0.15 kg of wetting agent, 0.15 kg of antifoaming agent, 26 kg of deionized water were added to continue to dispersedly stir for 30 min, so as to obtain the ceramic slurry used for coating, wherein the total solid content was 35%.

(2) The substrate in the Examples of the present disclosure was prepared by the following steps.

The ceramic layer was coated on two surfaces by using a concave roller, wherein the base film was a polyethylene or polypropylene microporous film with a thickness of 7 μm; the thickness of the single-surface coating layer was 2.5 μm; the coating speed was 60 m/min, the preheated temperature of the oven was 60° C. before coating, and the drying temperature of the oven was 60° C.

Different Examples and Comparative Examples were formed by changing experimental parameters. Table 1-Table 3 below show the experimental parameters and product parameters of each Example and Comparative Example. It should be noted that the molecular weight of the PVDF-HFP copolymer used in the Examples and the Comparative Examples were all 300,000, and only the percentage of HFP in the copolymer was different. Meanwhile, the thickness sum of the polymer layer at two sides was set as 4 μm, wherein the first ceramic particle was the small-particle-size (0.01-0.3 μm) ceramic particle, and its specific surface area was ≥50 m²/g.

TABLE 1

| Items | | Example 1 | Example 2 | Example 3 | Example 4 | Example 5 | Example 6 |
|---|---|---|---|---|---|---|---|
| Particle size of first | | 0.05 | 0.3 | 0.01 | 0.05 | 0.05 | 0.05 |
| ceramic particle μm | | | | | | | |
| Particle size of second | | 0.6 | 0.9 | 0.9 | 0.6 | 0.6 | 0.6 |
| ceramic particle μm | | | | | | | |
| Specific surface area of | | 90 | 90 | 90 | 90 | 90 | 90 |
| first ceramic particle m²/g | | | | | | | |
| Percentage of first | | 20% | 10% | 20% | 5% | 20% | 20% |
| ceramic % | | | | | | | |
| Percentage of second | | 50% | 60% | 50% | 45% | 30% | 30% |
| ceramic % | | | | | | | |
| First high-adhesive | | PVDF-HFP | PVDF-HFP | PVDF-HFP | PVDF-HFP | PVDF-HFP | PVDF-HFP |
| resin | | (4%) | (4%) | (4%) | (4%) | (4%) | (20%) |
| Second high-heat- | | PEI | PI | PI | PEI | PEI | PEI |
| resistant resin | | (polyetherimide) | (polyimide) | (polyimide) | (polyetherimide) | (polyetherimide) | (polyetherimide) |
| Percentage of first | | 13% | 10% | 10% | 5% | 20% | 20% |
| resin % | | | | | | | |
| Percentage of second | | 17% | 20% | 20% | 45% | 30% | 30% |
| resin % | | | | | | | |
| Thickness of double- | | 4 | 4 | 4 | 4 | 4 | 4 |
| surface coating layer μm | | | | | | | |
| 150° C.*0.5 H | MD | 2.5 | 2 | 2 | 2 | 2.8 | 3 |
| separator heat | TD | 2 | 1.8 | 1.8 | 0.5 | 2.2 | 2.5 |
| shrinkage rate | | | | | | | |
| (%) | | | | | | | |
| Liquid absorption g/m² | | 6.5 | 7 | 6.2 | 6.1 | 6.5 | 6.5 |
| Adhesion | Surface A | 70 | 67 | 69 | 55 | 73 | 65 |
| performance of | Surface B | 76 | 72 | 70 | 62 | 76 | 60 |
| the electrode | | | | | | | |
| plate gf/25 mm | | | | | | | |

TABLE 2

| Items | | Example 7 | Example 8 | Example 9 | Example 10 | Example 11 |
|---|---|---|---|---|---|---|
| Particle size of first | | 0.05 | 0.01 | 0.01 | 0.25 | 0.03 |
| ceramic particle μm | | | | | | |
| Particle size of second | | 0.6 | 0.9 | 1 | 0.45 | 0.35 |
| ceramic particle μm | | | | | | |
| Percentage of first | | 25% | 25% | 25% | 10% | 10% |
| ceramic % | | | | | | |
| Percentage of second | | 25% | 45% | 45% | 60% | 60% |
| ceramic % | | | | | | |
| First high-adhesive | | PVDF-HFP | PVDF-HFP | PVDF-HFP | PVDF-HFP | PVDF-HFP |
| resin | | (4%) | (4%) | (4%) | (4%) | (4%) |
| Second high-heat- | | PEI | PI | PI | PI | PI |
| resistant resin | | | | | | |
| Percentage of first | | 20% | 10% | 10% | 10% | 10% |
| resin % | | | | | | |
| Percentage of second | | 30% | 20% | 20% | 20% | 20% |
| resin % | | | | | | |
| Thickness of double- | | 4 | 4 | 4 | 4 | 4 |
| surface coating layer μm | | | | | | |
| 150° C.*0.5 H | MD | 2.8 | 2.5 | 3.2 | 2 | 3 |
| separator heat | TD | 2.1 | 1.9 | 2.5 | 1.5 | 2.1 |
| shrinkage rate | | | | | | |
| (%) | | | | | | |
| Liquid absorption g/m² | | 7 | 6.8 | 6.8 | 7.5 | 7 |
| Adhesion | Surface A | 72 | 65 | 63 | 67 | 69 |
| performance of | Surface B | 74 | 69 | 65 | 70 | 72 |
| the electrode | | | | | | |
| plate gf/25 mm | | | | | | |

TABLE 3

| | | Comparative | Comparative | Comparative | Comparative | Comparative |
|---|---|---|---|---|---|---|
| Items | | Example 1 | Example 2 | Example 3 | Example 4 | Example 5 |
| Particle size of first | | 0.4 | 0.05 | 0.05 | \ | 0.05 |
| ceramic particle μm | | | | | | |
| Particle size of second | | 0.9 | 0.9 | 0.9 | 0.6 | 0.6 |
| ceramic particle μm | | | | | | |
| Percentage of first | | 10% | 15% | 20% | \ | 20% |
| ceramic % | | | | | | |
| Percentage of second | | 15% | 10% | 50% | 75% | 50% |
| ceramic % | | | | | | |
| First high-adhesive | | PVDF-HFP | PVDF-HFP | PVDF-HFP | PVDF-HFP | PVDF-HFP |
| resin | | (4%) | (4%) | (3%) | (4%) | (4%) |
| Second high-heat- | | PEI | PEI | Polymethyl | PEI | \ |
| resistant resin | | (polyetherimide) | (polyetherimide) | methacrylate | (polyetherimide) | |
| Percentage of first | | 15% | 15% | 13% | 8% | 30% |
| resin % | | | | | | |
| Percentage of second | | 60% | 60% | 17% | 17% | \ |
| resin % | | | | | | |
| Thickness of double- | | 4 | 4 | 4 | 4 | 4 |
| surface coating layer μm | | | | | | |
| 150° C.*0.5 H | MD | 10.8 | 16.5 | 15.8 | 17.5 | 25 |
| separator heat | TD | 8.2 | 14 | 14.5 | 16.5 | 22 |
| shrinkage rate | | | | | | |
| (%) | | | | | | |
| Liquid absorption g/m² | | 5.4 | 5.4 | 5.4 | 6.5 | 6.5 |
| Adhesion | Surface A | 30 | 35 | 30 | 28 | 45 |
| performance of | Surface B | 45 | 44 | 40 | 35 | 49 |
| the electrode | | | | | | |
| plate gf/25 mm | | | | | | |

PEI was polyetherimide and PI was polyimide.

The first polymer percentage and the second polymer percentage in the tables herein refer to the percentages of the first polymer and the second polymer in the dry weight of the coating layer respectively. The first ceramic percentage and the second ceramic percentage refer to the percentages of the first ceramic and the second ceramic in the dry weight of the coating layer respectively. The adhesion performance of electrode plate refers to the adhesive force test result of two opposite surfaces of the separator to the electrode plate.

As can be seen from the above Examples and Comparative Examples, the separator prepared by the present disclosure has significantly improved in adhesive force; the 150° C. heat shrinkage rate is smaller than or equal to 5.0%; and the liquid absorption is maintained at more than 6.0 g/m².

In some other Examples, the polymer layer was coated on two sides of the base film. The coated separator can be prepared by the following steps.

The polymer-layer coating slurry obtained above was coated on surfaces of two opposite surface layers of the PE separator by using the slightly concave roller; and the coated substrate was immersed in the solidification tank at the temperature of 20° C. and with the mixture solvent concentration of 20% (the mass-percentage ratio concentration of the first solvent in the mixture included first solvent and second solvent) for the phase conversion, and the coated separator (i.e., battery separator) was obtained after the non-solvent washing and oven drying. The first solvent includes at least one of acetone, dichloromethane, benzene, toluene, xylene, dimethylformamide, dimethylsulfoxide, trimethyl phosphate, cyclohexane, cyclohexanone, toluene cyclohexanone, chlorobenzene, dichlorobenzene, dichloromethane, ethyl ether, propylene oxide, methylethyl ketone, methylbutyl ketone, methylisobutyl ketone, ethylene glycol monomethyl ether, ethylene glycol monoethyl ether, ethylene glycol monobutyl ether, tetrahydrofuran, trichloromethane, and N-methyl-2-pyrrolidinone; and the second solvent includes at least one of ethanol, water, glycerol, ethyl acetate, and polyethylene glycol. The first solvent in Examples and Comparative Examples of the present disclosure was N-methyl-2-pyrrolidone, and the second solvent was water.

The preparation methods in Table 4-Table 5 were the same as those in Table 1-Table 3 above, and the difference was that the step of substrate was omitted, that is, the polymer layer was directly coated on the PE base film.

TABLE 4

| Items | | Example 12 | Example 13 | Example 14 | Example 15 | Example 16 | Example 17 |
|---|---|---|---|---|---|---|---|
| Particle size of first | | 0.05 | 0.3 | 0.01 | 0.05 | 0.05 | 0.05 |
| ceramic particle μm | | | | | | | |
| Particle size of second | | 0.6 | 0.9 | 0.9 | 0.6 | 0.6 | 0.6 |
| ceramic particle μm | | | | | | | |
| Percentage of first | | 20% | 10% | 20% | 5% | 20% | 20% |
| ceramic % | | | | | | | |
| Percentage of second | | 50% | 60% | 50% | 45% | 30% | 30% |
| ceramic % | | | | | | | |
| First high-adhesive | | PVDF-HFP | PVDF-HFP | PVDF-HFP | PVDF-HFP | PVDF-HFP | PVDF-HFP |
| resin | | (4%) | (4%) | (4%) | (4%) | (4%) | (20%) |
| Second high-heat- | | PEI | PI | PI | PEI | PEI | PEI |
| resistant resin | | (polyetherimide) | (polyimide) | (polyimide) | (polyetherimide) | (polyetherimide) | (polyetherimide) |
| Percentage of first | | 13% | 10% | 10% | 5% | 20% | 20% |
| resin % | | | | | | | |
| Percentage of second | | 17% | 20% | 20% | 45% | 30% | 30% |
| resin % | | | | | | | |
| Thickness of double- | | 4 | 4 | 4 | 4 | 4 | 4 |
| surface coating layer μm | | | | | | | |
| 150° C.*0.5 H | MD | 7.5 | 7.8 | 7.5 | 7 | 6.9 | 7.5 |
| separator heat | TD | 6.3 | 5 | 4 | 7 | 5 | 6.8 |
| shrinkage rate | | | | | | | |
| (%) | | | | | | | |
| Liquid absorption g/m² | | 6.8 | 6.9 | 6.5 | 6.8 | 6.5 | 6.2 |
| Adhesion | Surface A | 70 | 67 | 62 | 53 | 69 | 71 |
| performance of | Surface B | 71 | 68 | 65 | 60 | 71 | 75 |
| the electrode | | | | | | | |
| plate gf/25 mm | | | | | | | |

TABLE 5

| | | Comparative | Comparative | Comparative | Comparative | Comparative |
|---|---|---|---|---|---|---|
| Items | | Example 6 | Example 7 | Example 8 | Example 9 | Example 10 |
| Particle size of first | | 0.4 | 0.05 | 0.05 | \ | 0.05 |
| ceramic particle μm | | | | | | |
| Particle size of second | | 0.9 | 0.9 | 0.9 | 0.6 | 0.6 |
| ceramic particle μm | | | | | | |
| Percentage of first | | 10% | 15% | 20% | \ | 20% |
| ceramic % | | | | | | |
| Percentage of second | | 15% | 10% | 50% | 75% | 50% |
| ceramic % | | | | | | |
| First high-adhesive | | PVDF-HFP | PVDF-HFP | PVDF-HFP | PVDF-HFP | PVDF-HFP |
| resin | | (4%) | (4%) | (3%) | (4%) | (4%) |
| Second high-heat- | | PEI | PEI | Polymethyl | PEI | \ |
| resistant resin | | (polyetherimide) | (polyetherimide) | methacrylate | (polyetherimide) | |
| Percentage of first | | 15% | 15% | 13% | 8% | 30% |
| resin % | | | | | | |
| Percentage of second | | 60% | 60% | 17% | 17% | \ |
| resin % | | | | | | |
| Thickness of double- | | 4 | 4 | 4 | 4 | 4 |
| surface coating layer μm | | | | | | |
| 150° C.*0.5 H | MD | 11.2 | 15 | 46 | 35 | 54 |
| separator heat | TD | 15 | 13 | 44 | 32 | 58 |
| shrinkage rate | | | | | | |
| (%) | | | | | | |
| Liquid absorption g/m² | | 5 | 5.2 | 5.1 | 6.1 | 6.1 |
| Adhesion | Surface A | 35 | 32 | 50 | 25 | 55 |
| performance of | Surface B | 41 | 40 | 41 | 32 | 60 |
| the electrode | | | | | | |
| plate gf/25 mm | | | | | | |

As can be seen from the above Examples and Comparative Examples, the separator prepared by the present disclosure has significantly improved in adhesive force; the 150° C. heat shrinkage rate (under the test condition of 0.5 h) is smaller than or equal to 8.0%; and the liquid absorption is maintained at more than 6.0 g/m².

The embodiments of the present disclosure further provide a battery, including the battery separator involved in the above optional embodiments.

In the description of the specification, referring to the terms “an embodiment”, “an implementation example”. “a specific implementation process”, and “an example”, etc., it means that the specific feature, structure, material, or characteristic described in connection with the embodiment or example are included in at least one embodiment or example of the present disclosure. In the specification, the schematic descriptions of the above terms do not necessarily refer to the same embodiments or examples. Moreover, the specific feature, structure, material, or characteristic described may be combined in any one or more embodiments or examples in a suitable manner.

Finally, it should be noted that the above embodiments are only used to illustrate the technical solutions of the present disclosure, and not to restrict it. Although the present disclosure is described in detail with reference to the foregoing embodiments, a person of ordinary skill in the art should understand that it is still possible to modify the technical solutions recorded in the foregoing embodiments or to make equivalent substitutions for some or all of the technical features therein; and these modifications or replacements do not take the essence of the corresponding technical solutions out of the scope of the technical solutions of the embodiments of the present disclosure.

What is claimed is:

1. A battery separator, comprising a substrate, wherein a polymer layer is coated on one side or two sides of the substrate, and the polymer layer is formed by mixing a first polymer, a second polymer, a first ceramic particle, and a second ceramic particle, wherein particle sizes of the first ceramic particle and the second ceramic particle are 0.01 μm-1 μm, and a surface area of the first ceramic particle is ≥50 m²/g.

2. The battery separator according to claim 1, wherein the particle size of the first ceramic particle is 0.01-0.3 μm.

3. The battery separator according to claim 1, wherein the particle size of the second ceramic particle is 0.3-1 μm, and the particle size of the first ceramic particle is smaller than the particle size of the second ceramic particle.

4. The battery separator according to claim 1, wherein a mass-percentage ratio of the first ceramic particle to the second ceramic particle is: 10%-50%: 50%-90%.

5. The battery separator according to claim 4, wherein the mass-percentage ratio of the first ceramic particle to the second ceramic particle is: 10%-35%: 65%-90%.

6. The battery separator according to claim 1, wherein the first polymer is a high-adhesive polymer resin, and the high-adhesive polymer resin is a binder resin, wherein a dry-press adhesive force of the battery separator is ≥20 N/m, and a wet-press adhesive force of the battery separator is ≥8 N/m.

7. The battery separator according to claim 6, wherein the high-adhesive polymer resin comprises a copolymer of polyvinylidene difluoride and hexafluoropropylene, sodium carboxymethyl cellulose, and a polymethacrylate polymer.

8. The battery separator according to claim 7, wherein in the copolymer of polyvinylidene difluoride and hexafluoropropylene, a mass percentage of the hexafluoropropylene in the copolymer is 4% to 20%; a molecular weight of the copolymer of polyvinylidene difluoride and hexafluoropropylene is 300,000 to 500,000; a melting point of the copolymer of polyvinylidene difluoride and hexafluoropropylene is 125˜150° C.; and a melt viscosity of the copolymer of polyvinylidene difluoride and hexafluoropropylene is 15˜35 cps.

9. The battery separator according to claim 1, wherein the second polymer is a heat-resistant polymer resin having a melting point larger than or equal to 180° C.

10. The battery separator according to claim 9, wherein the heat-resistant polymer resin comprises one or two of polyetherimide, polyimide, polyvinylidene fluoride-tetrafluoroethylene-propylene terpolymer, and polyvinylidene difluoride-trifluoroethylene-chlorotrifluoroethylene terpolymer.

11. The battery separator according to claim 1, wherein a mass-percentage ratio of the first polymer to the second polymer is: 10˜40%:60˜90%.

12. The battery separator according to claim 1, wherein based on a mass sum of the first polymer, the second polymer, the first ceramic particle, and the second ceramic particle in the polymer layer, a mass percentage of a sum of the first ceramic particle and the second ceramic particle in the polymer layer is 30% to 70%.

13. The battery separator according to claim 1, wherein the polymer layer comprises a ceramic particle, wherein raised island structures are formed on a surface of the polymer layer.

14. The battery separator according to claim 13, wherein a diameter of the raised island structures is 0.8-2 μm.

15. A preparation method of a battery separator for preparing the battery separator according to claim 1, comprising:
selecting the first polymer and the second polymer, and dissolving a mixture of the first polymer and the second polymer in a first solvent to obtain a premixed slurry A;
screening the first ceramic particle and the second ceramic particle, wherein the particle sizes of the first ceramic particle and the second ceramic particle are 0.01 μm-1 μm, and the surface area of the first ceramic particle is ≥50 m²/g;
adding two types of the first and second ceramic particles of different particle sizes simultaneously or successively to the premixed slurry A and mixing, to obtain a polymer-layer coating slurry; and
coating the polymer-layer coating slurry on one side or two sides of the substrate, so as to obtain the battery separator.

16. A battery, comprising a battery separator, a positive electrode, a negative electrode, and an electrolyte, wherein the battery separator is the battery separator according to claim 1.

17. The preparation method according to claim 15, wherein after coating the polymer-layer coating slurry on the one side or two sides of the substrate to obtain a coated substrate, the preparation method further comprises conveying the coated substrate into a coagulating bath containing a coagulating solution consisting of a second solvent or a mixture of the second solvent with an identical solvent as the first solvent and drying the coated substrate.

18. The preparation method according to claim 17, wherein the first solvent comprises at least one of acetone, dichloromethane, benzene, toluene, xylene, dimethylformamide, dimethylsulfoxide, trimethyl phosphate, cyclohexane, cyclohexanone, toluene cyclohexanone, chlorobenzene, dichlorobenzene, dichloromethane, ethyl ether, propylene oxide, methylethyl ketone, methylbutyl ketone, methylisobutyl ketone, ethylene glycol monomethyl ether, ethylene glycol monoethyl ether, ethylene glycol monobutyl ether, tetrahydrofuran, trichloromethane, and N-methyl-2-pyrrolidinone; and the second solvent comprises at least one of ethanol, water, glycerol, ethyl acetate, and polyethylene glycol.

19. The battery according to claim 16, wherein the particle size of the first ceramic particle is 0.01-0.3 μm; the particle size of the second ceramic particle is 0.3-1 μm, and the particle size of the first ceramic particle is smaller than the particle size of the second ceramic particle.

20. The battery according to claim 19, wherein a mass-percentage ratio of the first ceramic particle to the second ceramic particle is: 10%-35%: 65%-90%.
